(19) United States
(12) Patent Application Publication
(10) Pub. No.: US 2010/0304066 A1
(43) Pub. Date: Dec. 2, 2010

(54) POLYLACTIC ACID FILAMENT NONWOVEN FABRIC AND PRODUCTION METHOD THEREOF

(75) Inventor: Atsushi Matsunaga, Aichi (JP)

Correspondence Address: FILDES & OUTLAND, P.C., 20916 MACK AVENUE, SUITE 2, GROSSE POINTE WOODS, MI, 48236, US

(73) Assignee: UNITIKA LTD., Hyogo (JP)

(21) Appl. No.: 12/539,686

(22) Filed: Aug. 12, 2009

(30) Foreign Application Priority Data
May 29, 2009 (JP) 2009-129740

(51) Int. Cl. B32B 1/02; D04H 3/16

(52) U.S. Cl. 428/36.1; 442/401; 442/364; 264/115

(57) ABSTRACT

A nonwoven fabric formed of composite filaments by a spunbond method is disclosed. The composite filament includes a polylactic acid polymer having a melting point of 160° C. or higher and an aliphatic polyester polymer having a melting point lower, by 50° C. or more, than the melting point of the polylactic acid polymer. The aliphatic polyester polymer forms at least a portion of the filament surface. The aliphatic polyester polymer includes as the constituent components thereof 1,4-butanediol and succinic acid, and at the same time, includes 0.1 to 1% by mass of an amide wax.

### FIELD OF THE INVENTION

The present invention relates to a nonwoven fabric and a production method thereof.

### BACKGROUND OF THE INVENTION

An example of nonwoven fabrics having functionalities is a nonwoven fabric made of a self-adhesive fiber. The nonwoven fabric made of a self-adhesive fiber is a fabric in which the fibers bond to each other to be integrated through melting of portions of the fibers by heating and which has a heat-sealing property.

In these years, it is generally recognized that synthetic fibers derived from petroleum as raw materials are large in the heat generated when incinerated and hence are needed to be reconsidered from the viewpoint of the protection of the natural environment. As a response to such recognition, fibers made of aliphatic polyesters biodegradable in nature have been developed, and are expected to contribute to the protection of the environment. Among the aliphatic polyesters, polylactic acid polymers each have a melting point as comparatively high as about 180° C., and hence are expected to be used in wide fields.

Known as the nonwoven fabrics made of self-boding fibers using polylactic acid polymers are nonwoven fabrics made of sheath-core type fibers in each of which polylactic acid is disposed in the core portion thereof and a copolymer of L-lactic acid and D-lactic acid (D,L-lactic acid copolymer) is disposed in the sheath portion thereof and thus the sheath portion has a melting point lower than that of the core portion (Japanese Patent Laid-Open Nos. 07-310236 and 07-133511).

In this case, considering the heat processing stability, preferable is a composite fiber in which the melting point difference between the core portion and the sheath portion is as large as possible. Accordingly, it is conceived that a copolymer having a lower melting point (a copolymer having a melting point of about 120° C.) is preferably selected as the copolymer for the sheath portion. However, of the D,L-lactic acid copolymers, the copolymers having a melting point of about 120° C. are low in crystallinity. Consequently, when nonwoven fabrics made of such sheath-core type fiber are applied for heat-sealing, troubles such as shrinkage in a thermal bonding step or fusion bonding to a hot roller tend to occur. Additionally, nonwoven fabrics obtained from such sheath-core type fiber are poor in heat resistance.

As an alternative choice, there has been investigated the selection of polymers, having a low melting point, other than polylactic acid for the sheath portion. However, in this case, the glass transition points of such polymers are frequently low. Accordingly, when a nonwoven fabric is intended to be obtained by the so-called spunbond method, the distance, in the spunbond method, over which the filaments discharged from the orifices of the nozzles are drawn to be made thinner (distance between the spinning step and the cooling and stretching step) is extremely short. Consequently, when a nonwoven fabric is obtained by the spunbond method by using such a sheath-core type filament, there occur a problem that no sufficient cooling is performed in the cooling step and rubber-like elasticity is exhibited, a problem that mutual sticking occurs between filaments in the spreading-open step, and other problems.

Known as a method for solving such a problem is a technique which, when a low melting point polymer other than polylactic acid is used for the sheath portion, controls the crystallization rate of the polymer by a crosslinking reaction using an organic peroxide and performs cooling by a short cooling process (Japanese Patent Laid-Open No. 2007-084988).

In the case of this technique, by increasing the crystallization rate of the polymer used for the sheath portion on the basis of the crosslinking reaction, the cooling of the filaments is sufficiently enabled even when the cooling step is a short step as it is the case in the spunbond method. Consequently, the mutual sticking of the filaments is eliminated and a satisfactory spreading-open property (the uniformity of the nonwoven fabric) can be obtained. On the other hand, the polymer has been crosslinked, and hence the rubber elasticity of the polymer comes to be more enhanced than when the polymer is not crosslinked. Accordingly, there occurs a problem that narrow is the range of the reaction conditions which provide a satisfactory balance between the crosslinking reaction and the spreading-open property, both capable of putting up with high-speed spinning.

Japanese Patent Laid-Open No. 2007-119928 discloses a composite fiber including a first biodegradable component and a second biodegradable component, and further describes a biodegradable composite fiber characterized in that the semi-crystallization time of the second component at 85° C. is longer than the semi-crystallization time of the first component at 85° C., and a structure and a water absorption article using the biodegradable composite fiber. In the case where a composite fiber is produced by using different biodegradable resins, when biodegradable resins small in the mutual crystallization rate difference are used, the cooling of the biodegradable resin having a longer semi-crystallization time is disturbed, in the spinning step, by the heat generated when the biodegradable resin having a shorter semi-crystallization time is crystallized. Therefore, the difference of the semi-crystallization time between the first component and the second component is set to be large. Consequently, it is possible to prevent the problem that the cooling of the biodegradable resin having a longer semi-crystallization time is disturbed by the heat generated when the biodegradable resin having a shorter semi-crystallization time is crystallized.

The composite fiber described in this document, Japanese Patent Laid-Open No. 2007-119928, can be sufficiently satisfactorily applied when the length of the cooling zone in the spinning step can be sufficiently ensured. However, in the case where the spunbond method having a short cooling zone is adopted, when a resin having a longer semi-crystallization time is applied for the polymer for the sheath portion, sticking of filaments is caused.

### DISCLOSURE OF THE INVENTION

A problem of the present invention is to provide a biodegradable nonwoven fabric that is satisfactory in the spinability and the spreading-open property of the constituent continuous filaments and is capable of being produced by the spunbond method and to provide a production method of the nonwoven fabric. Moreover, another problem of the present invention is to provide a biodegradable nonwoven fabric that is excellent in mechanical properties, has at the same time the heat-sealing property and is particularly excellent in flexibility and to provide a production method thereof.

For the purpose of solving the above-described problems, the present inventors made an investigation to obtain, by the spunbond method, a nonwoven fabric even with a polymer having a low melting point and a low glass transition temperature. Consequently, it has been revealed that by selecting a specific polymer as an aliphatic polyester polymer which forms at least a portion of the filament surface such as the sheath component, and by further adding an amide wax to this polymer, the crystallization rate can be increased without adding an organic peroxide for crosslinking reaction, and sufficient cooling is performed even in the cooling step based on the spunbond method so as to cause no sticking. The present invention has been perfected on the basis of the above-described findings.

The means for solving the above-described problems are as follows.

1. A nonwoven fabric which is formed of composite filaments by a spunbond method, wherein:

the composite filament comprises a polylactic acid polymer having a melting point of not lower than 160° C. and an aliphatic polyester polymer having a melting point lower, by not less than 50° C., than the melting point of the polylactic acid polymer;

the aliphatic polyester polymer forms at least a portion of a filament surface; and

the aliphatic polyester polymer comprises as constituent components thereof 1,4-butanediol and succinic acid, and at the same time, comprises 0.1 to 1% by mass of an amide wax.

2. The nonwoven fabric according to claim 1, wherein the fabric is formed of composite filaments which are sheath-core type filaments in which the polylactic acid polymer forms a core portion thereof and the aliphatic polyester polymer forms a sheath portion thereof, and a composite ratio between the core portion and the sheath portion satisfies a relation that core portion/sheath portion=3/1 to 1/3 by mass ratio.

3. The nonwoven fabric according to claim 1, wherein:

when differential thermal analysis is performed at a temperature decrease rate of 10° C./min after melting has been performed at a temperature increase rate of 10° C./min, a crystallization temperature Tc1 on cooling due to the polylactic acid polymer and a crystallization temperature Tc2 on cooling due to the aliphatic polyester polymer are present; Tc2 is not lower than 80° C. and not higher than 90° C.; and a heat of crystallization Hexo2 of the aliphatic polyester polymer is not less than 30 J/g.

4. A production method of a nonwoven fabric comprising the steps of: preparing a polylactic acid polymer having a melting point of not lower than 160° C. and an aliphatic polyester polymer which comprises, as constituent components thereof, 1,4-butanediol and succinic acid and has a melting point lower, by not less than 50° C., than the melting point of the polylactic acid polymer; mixing an amide wax so as to have a content of 0.1 to 1% by mass in the aliphatic polyester polymer; melting separately the polylactic acid polymer and the aliphatic polyester polymer at a temperature of (Tm+75)° C. to (Tm+120)° C. wherein the Tm is the melting point of the aliphatic polyester polymer; performing spinning by using a composite spinneret which allows the aliphatic polyester polymer to form at least a portion of a filament surface in a filament cross section; cooling, drawing and subsequently spreading-open filaments that have been spin-twisted from the spinneret; and forming a nonwoven web by depositing thus obtained filaments.

5. The production method of a nonwoven fabric according to claim 4, wherein used as the aliphatic polyester polymer is a polymer which has a crystallization rate index of 3 to 10 minutes as determined by a differential thermal analysis of an isothermal crystallization performed under the conditions that the polymer is heated to 200° C. at a temperature increase rate of 500° C./min, the polymer is maintained at 200° C. for 5 minutes, thereafter the polymer is cooled to 90° C. at a temperature decrease rate of 500° C./min and the polymer is maintained at 90° C. for crystallization, and has a melt viscosity gradient of not more than 20 g/10 min obtained as a difference between a melt flow rate at 230° C. with a load of 20.2 N (2160 gf) and a melt flow rate at 210° C. with a load of 20.2 N (2160 gf), both of the melt flow rates being measured according to a method described in ASTM-D-1238(E).

6. The production method of a nonwoven fabric according to claim 4, wherein used as the polylactic acid polymer and the aliphatic polyester polymer are these two polymers for which a melt flow rate ratio measured at 210° C. with a load of 20.2 N (2160 gf) according to the method described in ASTM-D-1238(E) satisfies a relation that the melt flow rate of the aliphatic polyester polymer/the melt flow rate of the polylactic acid polymer=0.3 to 1.5, and a melt flow rate ratio measured at 230° C. with a load of 20.2 N (2160 gf) according to the method described in ASTM-D-1238(E) satisfies a relation that the melt flow rate of the aliphatic polyester polymer/the melt flow rate of the polylactic acid polymer=not more than 0.7.

7. A biodegradable bag-shaped article which is formed of the nonwoven fabric according to claim 1, and is allowed to take a bag-shaped structure by being provided with a heat-sealing portion in which constituent filaments are bonded to each other due to melting or softening of the aliphatic polyester polymer.

8. A biodegradable sanitary article which is formed of the nonwoven fabric according to claim 1.

According to the nonwoven fabric and the production method thereof of the present invention, the aliphatic polyester polymer, forming at least a portion of the filament surface, contains 0.1 to 1% by mass of an amide wax, and consequently the friction between the filaments at the time of spreading-open can be diminished. Thus, a web satisfactory in spreading-open property can be produced, and hence a nonwoven fabric satisfactory in uniformity can be obtained.

According to the production method of the present invention, used as the aliphatic polyester polymer is a specific aliphatic polyester polymer which has a crystallization rate index of 3 to 10 minutes and a melt viscosity gradient of 20 g/10 min or less obtained as the difference between a melt flow rate at 230° C. and a melt flow rate at 210° C., both of the melt flow rates being measured according to the method described in ASTM-D-1238(E), and hence the crystallization rate of the aliphatic polyester polymer can be increased. Therefore, even in the production process of the spunbond nonwoven fabric in which process the distance between the spinning step and the cooling and stretching step is necessarily a limited shorter distance as compared to the production process of a staple-fiber nonwoven fabric or the like, the aliphatic polyester polymer can be satisfactorily cooled and crystallized without developing therein such elasticity at the time of melting as developed by the crosslinking reaction. Thus, the occurrence of the sticking in the spreading-open step can be effectively suppressed.

Moreover, according to the present invention, there can be obtained the nonwoven fabric made of the composite filaments including the polylactic acid polymer and the aliphatic polyester polymer which includes, as the constituent components thereof, 1,4-butanediol and succinic acid and has a melting point lower, by 50° C. or more, than the melting point of the polylactic acid polymer. Consequently, there can be obtained a nonwoven fabric excellent in the stability at the time of heat processing and in the heat-sealing property.

### DESCRIPTION OF THE EMBODIMENTS

The nonwoven fabric of the present invention is constituted with composite continuous filaments that includes a polylactic acid polymer, as a filament-forming component, having a melting point of 160° C. or higher and an aliphatic polyester polymer, as a thermobonding component, having a melting point lower than the melting point of the polylactic acid polymer.

First, the polylactic acid polymer is described.

In the present invention, used as the polylactic acid polymer is a polymer having a melting point of 160° C. or higher or a polymer blend composed of polymers each having a melting point of 160° C. or higher. The polylactic acid polymer has a high crystallinity owing to the melting point thereof being 160° C. or higher, and thus the shrinkage at the time of heat treatment processing is unlikely to occur and the heat treatment processing can be performed stably.

The melting point of poly-L-lactic acid or poly-D-lactic acid that is a homopolymer of lactic acid is approximately 180° C. When a copolymer between L-lactic acid and D-lactic acid is used as the polylactic acid polymer, the copolymerization ratio between the monomer components is determined in such a way that the melting point of the copolymer is 160° C. or higher. Specifically, used is the copolymer having a copolymerization ratio between L-lactic acid and D-lactic acid, (L-lactic acid)/(D-lactic acid)=2.0/98.0 to 0/100 or (L-lactic acid)/(D-lactic acid)=98.0/2.0 to 100/0 by molar ratio. When the copolymerization ratio deviates from the above-described ranges, the melting point of the copolymer is lower than 160° C. to preclude the attainment of the object of the present invention. More preferably, the melting point is 165° C. or higher.

To the polylactic acid polymer, where necessary, various additives such as a delustering agent, a pigment and a crystal nucleating agent may be added within the ranges that do not impair the advantages of the present invention. For the purpose of increasing the crystallization rate of the polylactic acid polymer, it is particularly useful to use a crystal nucleating agent such as talc, boron nitride, calcium carbonate or a titanium oxide in a range from 0.1 to 3% by weight.

Next, the aliphatic polyester polymer having a melting point lower than the melting point of the polylactic acid polymer is described.

The aliphatic polyester polymer concerned is a polymer that includes as the main constituent components thereof 1,4-butanediol and succinic acid.

As such an aliphatic polyester polymer, specifically a product manufactured by Mitsubishi Chemical Corporation under a brand name GSPla (crystal melting point 110° C.) can be preferably used. It is to be noted that for the purpose of making satisfactory the thermal bond for the formation of nonwoven fabric and making satisfactory the heat-sealing property of the obtained nonwoven fabric, it is necessary that the melting point difference between the polylactic acid polymer and the aliphatic polyester polymer be 50° C. or more.

As the aliphatic polyester polymer including as the main constituent components thereof 1,4-butanediol and succinic acid, any aliphatic polyester polymers which do not contain isocyanate can be used. Addition of isocyanate may cause a problem that aliphatic polyester polymers that contain a urethane bond are colored, or generate microgel depending on the conditions when nonwoven fabrics are formed from these polymers.

The aliphatic polyester polymer, at a stage of being a raw material (an aliphatic polyester polymer that does not contain the below-described amide wax), preferably has the crystallization rate index (hereinafter, abbreviated as “tmax1” as the case may be) of 3 to 10 minutes as determined by the differential thermal analysis of the isothermal crystallization performed with a DSC apparatus under the conditions that the polymer is heated to 200° C. at a temperature increase rate of 500° C./min, the polymer is maintained at the condition of 200° C. for 5 minutes, thereafter the polymer is cooled to 90° C. at a temperature decrease rate of 500° C./min and the polymer is maintained at 90° C. for crystallization. The crystallization rate index tmax1 is indicated by the time (minutes) in which the degree of crystallization reaches half the finally reached degree of crystallization when the polymer is cooled from the molten state at 200° C. and is crystallized at 90° C., and it is meant that the smaller the index is, the faster the crystallization rate is. Therefore, by using an aliphatic polyester polymer having a high crystallization rate, namely, a crystallization rate index tmax1 of 3 to 10 minutes as the aliphatic polyester polymer to be a raw material for the composite filament, the cooling performance in melt-spinning comes to be satisfactory, and the sticking can be made unlikely to occur in spreading-open.

The aliphatic polyester polymer at a stage of being a raw material (an aliphatic polyester polymer that does not contain the below-described amide wax) preferably has a melt viscosity gradient, falling within a range of 10 g/10 min or less, as the difference between a melt flow rate at 230° C. and a melt flow rate at 210° C., both of the melt flow rates being measured according to the method described in ASTM-D-1238(E). A polymer having such a property is small in the degradation of the fluidity of the polymer due to the temperature and has a higher-order structure close to a crosslinked structure. Therefore, the crystallization rate index tmax1 can be made to be 3 to 10 minutes. Consequently, the cooling performance in melt-spinning comes to be satisfactory, and the sticking can be made unlikely to occur at the time of spreading-open.

The polylactic acid polymer and the aliphatic polyester polymer (the aliphatic polyester polymer that does not include the below-described amide wax) constituting the composite filament are preferably such that the melt flow rate ratio (the melt flow rate of the aliphatic polyester polymer/the melt flow rate of the polylactic acid polymer; hereinafter, abbreviated as “MFR ratio 1” as the case may be) measured at 210° C. with a load of 20.2 N (2160 gf) according to the method described in ASTM-D-1238(E) is 0.3 to 1.5, and the melt flow rate ratio (the same ratio as described above; hereinafter, abbreviated as “MFR ratio 2” as the case may be) measured at 230° C. with a load of 20.2 N (2160 gf) according to the method described in ASTM-D-1238(E) is 0.7 or less. The MFR ratio 1 and the MFR ratio 2 falling within the above-described ranges enables to prevent the problem that when the composite filament is subjected to melt-spinning, the cooling of the aliphatic polyester polymer is disturbed by the heat generated when the polylactic acid polymer is crystallized. Therefore, the sticking can be made unlikely to occur in the spreading-open step subsequent to the filament cooling.

With the aliphatic polyester polymer, an amide wax is to be melt-mixed. The mixing of the amide wax can attain the increase of the crystallization rate of the aliphatic polyester polymer and the effective prevention of the occurrence of the sticking in the spreading-open step through decreasing the friction resistance between filaments in the spreading-open step. Additionally, the mixing of the amide wax can attain the provision of excellent flexibility to filaments and nonwoven fabrics.

Examples of the amide wax include: aliphatic carboxylic acid amides such as aliphatic monocarboxylic acid amides, N-substituted aliphatic monocarboxylic acid amides, aliphatic biscarboxylic acid amides, N-substituted aliphatic carboxylic acid bisamides and N-substituted ureas; aromatic carboxylic acid amides; and hydroxyamides each of which further contains a hydroxyl group. These compounds may include one or two or more amide groups.

Preferable specific examples of the aliphatic monocarboxylic amides include dodecanamide, palmitic acid amide, oleamide, octadecanamide, cis-13-docesenoamide, docosanamide, [R—(Z)]-12-hydroxy-9-octadecenamide, and hydroxystearamide.

Preferable specific examples of the N-substituted aliphatic monocarboxylic acid amides include N-oleylpalmitic amide, N-oleyloleamide, N-oleylstearamide, N-stearyloleamide, N-stearylstearamide, N-stearyl-cis-13-docesenoamide, methylolstearamide and methyloldocosanamide.

Preferable specific examples of the aliphatic biscarboxylic acid amides include: methylenebis(stearamide), ethylenebis(stearamide), ethylenebis(dodecanamide), ethylenebis(decanamide), ethylenebis(oleamide), ethylenebis(cis-13-docesenoamide), ethylenebis(docosanamide), ethylene bisiso(stearamide), ethylene bishydroxy(stearamide), butylene bis(stearamide), hexamethylene bis(oleamide), hexamethylene bis(stearamide), hexamethylene bis(docosanamide), hexamethylene bishydroxy(stearamide), m-xylylene bis(oleamide), m-xylylene bis(stearamide), m-xylylene bis(docosanamide) and m-xylylene bishydroxy(stearamide).

Preferable specific examples of the N-substituted aliphatic carboxylic acid bisamides include dodecanamide,N,N′-1,2-ethanediylbis-, N,N′-ethylenebis(oleamide), N,N′-ethylenebis(stearamide), N,N′-methylenebis(stearamide), N,N′-ethane-1,2-diylbishexadecan-1-amide, N,N′-ethylenebis-12-hydroxystearamide, stearic acid monomethylol amide, N,N′-distearyl terephthalic acid amide and N,N′-hexamethylene-bis-12-hydroxystearyl amide.

Preferable specific examples of the N-substituted ureas include N-butyl-N′-stearyl urea, N-propyl-N′-stearyl urea, N-allyl-N′-stearyl urea and N-stearyl-N′-stearyl urea.

Among these, for example, the following bisamides are preferable because of the higher capability of improving the crystallization rate: N,N′-ethylenebis(oleamide), N,N′-ethylne-bis-ricinoleyl amide, N,N′-1,2-dodecanamide,N,N′-1,2-ethanediylbis-, N,N′-ethylenebis(stearamide), N,N′-ethane-1,2-diylbishexadecan-1-amide, N,N′-ethylenebis-12-hydroxy(stearamide), N,N′-hexamethylene-bis-12-hydroxy(steramide), ethylenebis(steariamide) and ethylenebis(doecanamide).

The mixing amount of the amide wax to be melt-mixed with the aliphatic polyester polymer is required to be 0.1 to 1% by mass, and is preferably 0.1 to 0.7% by mass and more preferably 0.1 to 0.5% by mass. The mixing amount of less than 0.1% by mass cannot reduce the friction resistance between filaments and is insufficient to suppress the occurrence of the sticking in the spreading-open step.

In this connection, the aliphatic polyester polymer that contains an amide wax as melt-mixed therein, at a stage of being a raw material, preferably has the crystallization rate index (hereinafter, abbreviated as “tmax2” as the case may be) of 2 minutes or less as determined by the differential thermal analysis of the isothermal crystallization performed with a DSC apparatus under the conditions that the polymer is heated to 200° C. at a temperature increase rate of 500° C./min, the polymer is maintained at the condition of 200° C. for 5 minutes to be melted, thereafter the polymer is cooled to 90° C. at a temperature decrease rate of 500° C./min and the polymer is maintained at 90° C. for crystallization. The crystallization rate index tmax2 is indicated by the time (minutes) in which the degree of crystallization reaches half the finally reached degree of crystallization when the polymer is cooled from the molten state at 200° C. and is crystallized at 90° C., and it is meant that the smaller the index is, the faster the crystallization rate is. Therefore, the aliphatic polyester polymer containing an amide wax as melt-mixed therein in a predetermined amount, as a raw material of the composite filament enables the crystallization rate index tmax2 to be 2 minutes or less. Consequently, such an aliphatic polyester polymer enables to reduce the friction resistance between filaments. Consequently, the composite filament using such an aliphatic polyester is satisfactory in the cooling performance when subjected to melt-spinning, and enables the sticking to be made unlikely to occur in spreading-open.

The melt-mixing of the amide wax enables the melt viscosity of the aliphatic polyester polymer to be reduced although the cause for such reduction is not clear. The aliphatic polyester polymer that contains no amide wax as mixed therein has suffered a problem that in the spinning step of the composite filament, sometimes increased is the viscosity of the aliphatic polyester polymer in a molten state, residing within the extruder to be subjected to spinning. However, the present invention is free from the occurrence of such a problem, and can alleviate the phenomenon, in the spinning step, that the viscosity of the aliphatic polyester polymer in a molten state is increased. Accordingly, the melt-mixing of the amide wax enables appropriate control of the melt tension in the spinning of the composite filament. Consequently, the composite filament can be produced in a satisfactory condition without causing failures such as filament breakage.

In the nonwoven fabric of the present invention, the aliphatic polyester polymer preferably includes 0.1 to 1.0% by mass of an N-substituted aliphatic biscarboxylic acid amide as the amide wax. When this is the case, a fabric having a low basis weight, namely, a basis weight of 30 g/m² or less, can be made to be a nonwoven fabric having a remarkably excellent in hand. Accordingly, such a nonwoven fabric can be preferably used in applications in which the nonwoven fabric directly touches the skin such as applications as sanitary articles.

Description is made on the relation between the crystallization rate of the polylactic acid polymer and the crystallization rate of the aliphatic polyester polymer.

The crystallization rate of the polylactic acid polymer is slow. Consequently, at the above-described temperature (90° C.) on which the crystallization rate of the aliphatic polyester polymer is measured, the isothermal crystallization of the polylactic acid polymer does not occur. Therefore, the crystallization rate of the polylactic acid polymer is inferred to be slower than the crystallization rate of the aliphatic polyester polymer.

In the step of producing the composite filament, the heat generated when the polylactic acid polymer having a slower crystallization rate is crystallized disturbs the cooling of the aliphatic polyester polymer forming at least a portion of the filament surface. However, in the present invention, the crystallization rate of the aliphatic polyester polymer is set to fall within the above-described range, and additionally an amide wax is added to increase the crystallization rate of the aliphatic polyester polymer. Consequently, the nonwoven fabric can be produced without being disturbed by the heat generated when the polylactic acid polymer is crystallized, and without causing the sticking between filaments in the spinning step and in the spreading-open step of the composite filament.

The polylactic acid polymer preferably has the crystallization rate index (hereinafter, abbreviated as “tmax3” as the case may be) of 10 minutes or less as determined by the differential thermal analysis of the isothermal crystallization performed with a DSC apparatus under the conditions that the polymer is heated to 200° C. at a temperature increase rate of 500° C./min, the polymer is maintained at the condition of 200° C. for 5 minutes to be melted, thereafter the polymer is cooled to 130° C. at a temperature decrease rate of 500° C./min and the polymer is maintained at 130° C. for crystallization.

In the present invention, the aliphatic polyester polymer forms at least a portion of the surface of the composite filament. Examples of the filament cross sectional shape for constituting such a filament include: a side-by-side type composite cross section in which the polylactic acid polymer and the aliphatic polyester polymer are bonded to each other; a sheath-core type cross section in which the polylactic acid polymer forms the core portion and the aliphatic polyester polymer forms the sheath portion; and a division-type cross section or a multifoil-type cross section in which the polylactic acid polymer and the aliphatic polyester polymer are made to be present alternately on the filament surface. The aliphatic polyester polymer plays a role as a thermobonding component in the heat-sealing step as described below. Therefore, in consideration of this point, the filament cross sectional shape is preferably the sheath-core type cross section in which the aliphatic polyester polymer forms the whole surface of the filament.

In the nonwoven fabric of the present invention, it is preferable that when differential thermal analysis is performed at a temperature decrease rate of 10° C./min after melting has been performed at a temperature increase rate of 10° C./min, the crystallization temperature Tc1 on cooling due to the polylactic acid polymer and the crystallization temperature Tc2 on cooling due to the aliphatic polyester polymer are present. Additionally, it is preferable that Tc2 be 80° C. or higher and 90° C. or lower, and the heat of crystallization Hexo2 of the aliphatic polyester polymer be 30 J/g or more.

The crystallization temperature Tc2 on cooling due to the aliphatic polyester polymer lower than 80° C. is not preferable because when the nonwoven fabric of the present invention is subjected to the heat-sealing processing as a posterior processing at such Tc2, it takes time to cool the sealing portion, so as to slow the processing speed.

In the case of the sheath-core type cross section in which the polylactic acid polymer forms the core portion as the filament-forming component and the aliphatic polyester polymer forms the sheath portion as the thermobonding component in the formation of the spunbond nonwoven fabric, the composite ratio (mass ratio) between the core portion and the sheath portion preferably satisfies the relation that core portion/sheath portion=3/1 to 1/3. When the ratio, core portion/sheath portion, exceeds 3/1, the proportion of the sheath portion comes to be too small; consequently the sheath-core type filament tends to be poor in thermobonding performance; accordingly, when the nonwoven fabric made of this sheath-core type filament retains the shape thereof through thermobonding, the shape retention property and the mechanical performances of the nonwoven fabric tend to be poor; and moreover, the nonwoven fabric made of this sheath-core type filament is unlikely to have a sufficient heat-sealing property. On the other hand, when the ratio, core portion/sheath portion, is less than 1/3, the mechanical strength of the nonwoven fabric made of this sheath-core type filament is insufficient.

The nonwoven fabric of the present invention is a spunbond nonwoven fabric made by depositing the above-described composite filament. The form of the nonwoven fabric is preferably a form in which the shape is retained through the thermobonding of the filaments to be bonded to each other due to the melting or the softening of the aliphatic polyester polymer component, and may also be a form in which the shape is retained by the entangle of the constituent filaments with each other. The form of the thermobonding may be a form in which thermobonding is effected at the contact points between the filaments through the aliphatic polyester polymer being melted or softened, or may be a form in which the thermobonding portions partially formed by passing through a hot embossing device and the rest non-thermobonding portions are involved, and in the thermobonding portions, the aliphatic polyester polymer component is melted or softened to retain the shape as the nonwoven fabric.

The fineness of the composite filament constituting the nonwoven fabric of the present invention is preferably 2 to 11 dtex. When the fineness is less than 2 dtex, the spin-twisted filaments cannot withstand the stretching tension in the spinning step, and the filament breakage is frequently caused. Consequently, the operability tends to be degraded. On the other hand, when the fineness exceeds 11 dtex, the cooling performance of the spin-twisted filament tends to be poor, and thus the filaments come to be discharged from the spreading-open device in a condition of being bonded to each other by heat. Consequently, the quality of the obtained nonwoven fabric comes to be extremely poor. From these reasons, the fineness is more preferably 3 to 8 dtex.

The basis weight of the nonwoven fabric of the present invention has only to be appropriately selected according to the applications of the nonwoven fabric without being particularly limited; however, in general, the weight of the nonwoven fabric of the present invention is preferably in a range from 10 to 300 g/m² and more preferably in a range from 15 to 200 g/m². When the basis weight is less than 10 g/m², the nonwoven fabric is poor in uniformity and mechanical strength to be unpractical. On the other hand, the weight exceeding 300 g/m² is disadvantageous with respect to the cost.

In particular, when heat-sealing is applied to the nonwoven fabric or when bag-shaped articles are formed by heat-sealing, the weight of the nonwoven fabric is preferably in a range from 15 to 150 g/m². When the weight is less than 15 g/m², the number of the filaments constituting the nonwoven fabric is relatively reduced, and hence the strength of the heat-sealing portion tends to be degraded. On the other hand, when the weight exceeds 150 g/m², the thickness of the nonwoven fabric is increased. Consequently, heat is not sufficiently transmitted to the inner layers in the heat-sealing portion in the heat-sealing processing, and hence such a nonwoven fabric tends to be unlikely to attain excellent heat-sealing strength.

To the polylactic acid polymer and/or the aliphatic polyester polymer for forming the composite filament that constitutes the nonwoven fabric of the present invention, as long as the object of the present invention is not significantly impaired, a crystal nucleating agent, a pigment, a thermostabilizer, an antioxidant, an antiweathering agent, a plasticizer, a lubricant, a mold-releasing agent, an antistatic agent, a filler and the like may be added.

The biodegradable bag-shaped article of the present invention is formed of the above-described nonwoven fabric. Specifically, the biodegradable bag-shaped article of the present invention is a bag-shaped article which is made to take a form of a bag by cutting the nonwoven fabric to an appropriate size and by forming the heat-sealing portions in the cut fabric.

In the heat-sealing portion, the filaments are bonded to each other by the melting or the softening of the aliphatic polyester polymer, and the polylactic acid polymer is not affected by the heat and is in a condition to maintain the shape of the filament. For the purpose of obtaining a bag-shaped article by forming such a heat-sealing portion, a heretofore known bag-making processing using a heat sealer can be applied. In this case, the treatment conditions (preset temperature, linear pressure, treatment speed) of the heat sealer can be appropriately set such that the aliphatic polyester polymer is melted or softened, and the polylactic acid polymer having a melting point higher than the melting point of the aliphatic polyester polymer is not affected by the heat.

The biodegradable bag-shaped article of the present invention may be a so-called bag having a take-out opening on one side of the bag, or alternatively, may be a bag which is made to contain various contents such as an exothermic agent, a desiccant and an insect repellent, and then closed by heat-sealing so as to have no opening.

The biodegradable sanitary article of the present invention is formed of the above-described nonwoven fabric. The nonwoven fabric used in the biodegradable sanitary article of the present invention is characterized in that the nonwoven fabric is excellent in flexibility, mechanical properties, dimensional stability and hand, and is simultaneously characterized in that when the nonwoven fabric is used in the formation of the sanitary article, thermal shrinkage of the nonwoven fabric is unlikely to occur in the heat treatment processing such as the bonding of the nonwoven fabric and other members to each other by heat-sealing or the heat-sealing processing.

The nonwoven fabrics used in the biodegradable sanitary article of the present invention are formed of the above-described composite filament. Among these nonwoven fabrics, preferable is a nonwoven fabric in which the constituent filaments bond to each other to be integrated through thermobonding, and particularly preferable is a nonwoven fabric in which the constituent filaments bond through thermobonding to each other by the embossing processing. In the nonwoven fabric undergoing thermobonding through the embossing processing, the thermobonding portions (the recessed portions formed in the nonwoven fabric) have been exerted with heat and pressure, but the non-thermobonding portions are substantially free from the effects of the heat and pressure. Consequently, the nonwoven fabric of the present invention comes to be a nonwoven fabric having satisfactory in hand. Additionally, such a nonwoven fabric is also satisfactory in mechanical properties and excellent in shape stability.

The weight of the nonwoven fabric in the sanitary article of the present invention has only to be selected according to the portions in the sanitary article in which portions the nonwoven fabric is used. Therefore, the weight of the nonwoven fabric is not particularly limited; however, in general, the weight of the nonwoven fabric is preferably 15 to 30 g/m². When the basis weight is less than 15 g/m², the number of the filaments present in a unit area is relatively reduced to give rise to a condition that holes are formed; thus, for example, when such a nonwoven fabric is used as the top sheet of a sanitary article, the back-wetting tends to occur when the sanitary article is worn, and there is a possibility that the feeling of discomfort is provoked. On the other hand, when the weight exceeds 30 g/m², the number of the filaments present in a unit area is relatively increased. Accordingly, such a nonwoven fabric tends to be poor in flexibility and permeability. Consequently, the portions in the sanitary article in which portions the nonwoven fabric is used tend to be limited.

In the nonwoven fabric used in the sanitary article of the present invention, the compression resistance thereof is preferably 40 cN or less. When the compression resistance exceeds 40 cN, the texture of the nonwoven fabric is stiff, and hence the portions in the sanitary article in which portions the nonwoven fabric is used tend to be limited. The nonwoven fabric having a smaller value of the compression resistance is soft and desirable. However, as a realistic value, the lower limit of the value of the compression resistance is approximately 10 cN.

The nonwoven fabric in the sanitary article of the present invention is characterized in that the nonwoven fabric is unlikely to undergo thermal shrinkage when used in the sanitary article, in particular, when subjected to a heat treatment processing such as bonding to other members by heat-sealing or heat-sealing processing, and is excellent in heat treatment processability. In other words, when the nonwoven fabric is allowed to stand in an atmosphere of (Tm-10)° C. for 5 minutes, the length thermal shrinkage percentage can be made to be 2% or less, wherein Tm is the melting point of the aliphatic polyester polymer that has a melting point, lower than the melting point of the polylactic acid polymer.

Next, a preferable production method of the nonwoven fabric of the present invention is described. The nonwoven fabric of the present invention is produced by the spunbond method.

Specifically, the polylactic acid polymer having a melting point of 160° C. or higher, the aliphatic polyester polymer having a melting point lower, by 50° C. or more, than the melting point of the polylactic acid polymer and including as the main constituent components thereof 1,4-butanediol and succinic acid, and an amide wax are prepared. Then, the polylactic acid polymer is melted, and separately the aliphatic polyester polymer and the amide wax are weighed out and mixed together and then melt-mixed in an extruder.

The temperature for melting is preferably in a range from (Tm+75)° C. to (Tm+120)° C. wherein Tm is the melting point of the aliphatic polyester polymer. When the temperature for melting is lower than (Tm+75)° C., the polylactic acid polymer cannot be sufficiently melted because the melting point of the polylactic acid polymer of the present invention is 160° C. or higher. Therefore, such a temperature for melting is in an insufficient temperature range for performing high-speed spinning. Alternatively, when the temperature for melting exceeds (Tm+120)° C., the heat entrained by the spin-twisted filament discharged from the spinneret is large. Therefore, the cooling capability of the aliphatic polyester polymer comes to be poor, and thus, sticking tends to occur at the time of spreading-open.

Then, spinning is performed by using a composite spinneret that allows the aliphatic polyester polymer to form at least a portion of the filament surface as viewed in the cross section of the filament. Next, the spin-twisted filament discharged from the spinneret is cooled with a heretofore known cooling device such as a transverse blow cooling device or a circular blow cooling device. Thereafter, the spin-twisted filament is drawn to be made thinner by using a suction device and then taken up.

The drawing speed in the drawing and thinning is preferably set at 1000 to 4000 m/min, and more preferably at 1000 to 3000 m/min. When the drawing speed is less than 1000 m/min, no sufficient molecular orientation is promoted in the filaments, and consequently the dimensional stability of the obtained nonwoven fabric tends to be poor. On the other hand, when the drawing speed exceeds 4000 m/min, spin-twisted filaments cannot withstand the drawing tension to cause filament breakage and thus the spinning stability tends to be poor. Such a phenomenon is inferred to occur on the basis of the following mechanism: the aliphatic polyester polymer used in the present invention has a melt viscosity gradient of 20 g/10 min or less and the viscosity decrease at the temperature for melting is small; therefore, the fluidity is not improved while the drawing speed is being increased through increasing the temperature for melting as usually conducted; and thus, it is inferred that the filaments cannot withstand the drawing tension to result in the filament breakage.

The drawn and thinned composite filaments are subjected to spreading-open with a heretofore known spreading-open device. In this connection, as described above, the aliphatic polyester polymer used in the present invention is a specific polymer in which the viscosity decrease at the temperature for melting is small, and the aliphatic polyester polymer concerned has a fast crystallization rate. Therefore, the aliphatic polyester polymer can be satisfactorily cooled and solidified even in the production process of the spunbond nonwoven fabric in which process the distance between the spinning step and the cooling and stretching step is necessarily a limited shorter distance as compared to the production process of a staple-fiber nonwoven fabric or the like, or alternatively, even in the case where a drawing speed of around 2000 m/min is adopted in the production step of this spunbond nonwoven fabric. Thus, the occurrence of the mutual sticking of the filaments in the spreading-open step using a spreading-open device can be effectively prevented.

After the spreading-open has been performed, the filaments are deposited on the movable capture surface such as a screen conveyer to form a nonwoven web. Thereafter, it is only necessary to form a nonwoven fabric by using a heretofore known technique for forming nonwoven fabric; for example, the nonwoven web can be subjected to a heat treatment in which the filaments are subjected to mutual thermobonding by softening or melting the aliphatic polyester polymer on the filament surface.

The technique for thermobonding is preferably such that a partial thermocompression bonding is applied by using a thermocompression bonding device such as a hot embossing device.

The temperature of the roller in the embossing device has only to be set at a temperature capable of melting or softening the aliphatic polyester polymer having a lower melting point, and is appropriately selected according to the treatment time, the linear pressure or the like. Specifically, the surface temperature of the roller is preferably set to fall within a range from the temperature lower by 20° C. than the melting point of the aliphatic polyester polymer having a lower melting point and to the melting point concerned. However, the surface temperature of the roller is lower, preferably by 30° C. or more and more preferably by 40° C. or more, than the melting point of the polylactic acid polymer, for the purpose of avoiding the situation that the polylactic acid polymer as the filament-forming component is melted or softened to fail in performing the proper function thereof.

When the temperature of the roller in the embossing device is set at a lower temperature that is lower by more than 20° C. than the melting point of the aliphatic polyester polymer having a lower melting point, the aliphatic polyester polymer as the thermobonding component is not sufficiently melted or softened. Consequently, such an aliphatic polyester polymer cannot undergo sufficient bonding. Further, the nonwoven fabric formed of a composite filament including such an aliphatic polyester polymer tends to undergo strength decrease, and also tends to be fuzzed. On the other hand, when the temperature of the roller in the embossing device is set at a higher temperature that exceeds the temperature higher by 20° C. than the melting point of the aliphatic polyester polymer having a lower melting point, the polylactic acid polymer tends to be readily affected by the heat, and consequently, the nonwoven fabric tends to undergo thermal shrinkage and is poor in mechanical strength as the case may be.

The heat treatment of the nonwoven web under the above-described temperature conditions enables the polylactic acid polymer to be heat treated at a temperature at which the polylactic acid polymer as the filament-forming component does not undergo the thermal effects such as thermal shrinkage. Consequently, such a nonwoven web is satisfactory in heat processing stability and enables the flexibility of the nonwoven fabric to be improved.

According to the present invention, the polyester polymer includes as the main constituent components thereof 1,4-butanediol and succinic acid, and has a specific melting property. Consequently, there can be obtained a nonwoven fabric and a bag-shaped article which are small in thermal shrinkage at the time of thermobonding and are additionally flexible.

### EXAMPLES

Next, the present invention is described specifically with reference to Examples. However, the present invention is not limited only to these Examples.

The measurements of the various physical property values in following Examples and Comparative Examples were performed by the following methods.

(1) Melting Point (° C.):

Melting points were measured by using a differential scanning calorimeter (model DSC-2, manufactured by Perkin-Elmer Corporation) under the conditions that the sample mass was set at 5 mg and the temperature increase rate was 10° C./min., and the temperatures that gave the maximum values of the obtained endothermic curves were defined as the melting points (° C.).

(2) Melt Flow Rates [MFR1] and [MFR2] (G/10 Min) of Polylactic Acid Polymer:

According to the method described in ASTM-D-1238(E), the melt flow rate “MFR1” measured under the conditions that the temperature was 210° C. and the load was 20.2 N (2160 gf) and the melt flow rate “MFR2” measured under the conditions that the temperature was 230° C. and the load was 20.2 N (2160 gf) were obtained.

(3) Melt Flow Rates [MFR3] and [MFR4] (G/10 Min) of Aliphatic Polyester Polymer:

According to the method described in ASTM-D-1238(E), the melt flow rate “MFR3” measured under the conditions that the temperature was 210° C. and the load was 20.2 N (2160 gf) and the melt flow rate “MFR4” measured under the conditions that the temperature was 230° C. and the load was 20.2 N (2160 gf) were obtained.

(4) Crystallization Rate Indexes (Min)

(4-1) Tmax1, Tmax2

The crystallization rate indexes were each measured by the differential thermal analysis of the isothermal crystallization performed with the differential scanning calorimeter (model DSC-2, manufactured by Perkin-Elmer Corporation) under the conditions that 5 mg of a sample was heated to 200° C. at a temperature increase rate of 500° C./min, the sample was maintained at the condition of 200° C. for 5 minutes, thereafter the sample was cooled to 90° C. at a temperature decrease rate of 500° C./min and the sample was maintained at 90° C. for crystallization.

The crystallization rate index tmax1 of the aliphatic polyester polymer and the crystallization rate index tmax2 of the melt-mixture wherein the melt-mixture was prepared by melt-mixing an amide wax with the aliphatic polyester polymer and by extruding the thus obtained melt-mixture at a temperature for melting of 200° C. were obtained.

(4-2) Tmax3

The crystallization rate index tmax3 of the polylactic acid polymer was measured by the differential thermal analysis of the isothermal crystallization performed with the differential scanning calorimeter (model DSC-2, manufactured by Perkin-Elmer Corporation) under the conditions that 5 mg of a sample was heated to 200° C. at a temperature increase rate of 500° C./min, the sample was maintained at the condition of 200° C. for 5 minutes to be melted, thereafter the sample was cooled to 130° C. at a temperature decrease rate of 500° C./min and the sample was maintained at 130° C. for crystallization.

(5) Crystallization Temperature (° C.) on Cooling, Heat Of Crystallization (J/G):

The crystallization exothermic curve was measured with a differential scanning calorimeter (model Pyris 1 DSC, manufactured by Perkin-Elmer Corporation) under the conditions that the sample mass was set at 10 mg and the temperature decrease rate was set at 10° C./min; the temperature giving the extreme value of the exothermic peak in the crystallization exothermic curve was defined as the crystallization temperature Tc2 (° C.) on cooling due to the aliphatic polyester polymer; and the heat obtained in this measurement was defined as the heat of crystallization Hexo2 (J/g).

(6) Fineness (Dtex):

The diameters of fifty fibers in a web state were measured with an optical microscope, and the average value obtained from the measured diameters by applying a density correction was defined as the fineness.

(7) Spreading-Open Property:

A nonwoven web formed of spin-twisted yarns discharged from a spreading-open device was visually evaluated on the basis of the following three grades.

E (excellent): Most of the constituent filaments are separated, and neither stuck filaments nor bundled filaments are found.

G (good): A small number of stuck filaments and a small number of bundled filaments are found.

P (poor): Most of the constituent filaments are stuck and the spreading-open property is poor.

(8) Weight (G/M²):

From a sample in a standard state, ten specimens each having a length of 10 cm and a width of 5 cm were prepared, and the mass (g) of each of the specimens was weighed, and the average value of the obtained values was converted into a value per unit area to be defined as the weight (g/m²).

(9) Tensile Strength (N/5 Cm Width) and Elongation (%):

Measurements were performed according to JIS-L-1906. Specifically, ten specimens each having a length of 20 cm and a width of 5 cm were prepared, and each of the specimens was elongated in the warp direction and the weft direction of the nonwoven fabric with a constant elongation tensile tester (Tensilon UTM-4-1-100, manufactured by Orientec Co., Ltd.) under the conditions that the grip separation was 10 cm and the tensile speed was 20 cm/min. The average value of the obtained fracture loads (N/5 cm width) at break was defined as the tensile strength (N/5 cm width), and the average value of the fracture elongations at break was defined as the elongation (%).

(10) Dimensional Stability of Nonwoven Fabric [Thermal Shrinkage Rate (%)]:

With Tm representing the melting point of the sheath portion of the sheath-core type filament constituting the nonwoven fabric, namely, the melting point of the aliphatic polyester polymer, a sample having a dimension of a machine direction (MD) length× a cross direction (CD) length=20 cm×20 cm was allowed to stand in an atmosphere of (Tm−10)° C. for 5 minutes, and thereafter the sample length of each of the directions was measured and represented by L, and the thermal shrinkage rate of each of the directions was calculated with the following formula. The case where the thermal shrinkage rates of the machine direction (MD) and the cross direction (CD) are both 5% or less was evaluated as satisfactory in the dimensional stability of the nonwoven fabric.

Thermal shrinkage rate (%)={(20−L)/20}×100

(11) Heat-Sealing Property T-Type Peeling Strength (N/3 Cm Width):

Two pieces of samples each having a width of 10 cm and a length of 5 cm were prepared. These two samples were superposed on each other and were subjected to a heat-sealing processing. On the basis of the workability in the heat-sealing processing, the heat-sealing property was determined by the following three grade evaluation.

G (good): In the heat-sealing processing, no shrinkage of the sealing portion is caused.

A (average): Shrinkage is caused in the heat-sealing portion, and the dimensional stability is poor.

P (poor): Almost no sealing is achieved.

The heat-sealing processing was applied under the conditions that, in a heat-sealing machine, the sealing width was set at 1 cm, the heat-sealing pressure was set at 19.6 N/cm², the heat-sealing time was set at 1 second and the heat-sealing temperature was set at the temperature described in Table 1 presented below. Then, the processed sheet was cut to the width of 3 cm. From the thus cut sheet, ten specimens were prepared. The T-type peeling strength of each of the specimens was measured with the constant elongation tensile tester (Tensilon UTM-4-1-100, manufactured by Orientec Co., Ltd.) while the heat-sealing portion was gradually being peeled under the conditions that the heat-sealing portion was positioned between the grips, the grip separation was 5 cm and the tensile speed was 20 cm/sec. During the T-type peeling, the maximum value and the minimum value of the load were read off, and the average of these values was defined as the peeling strength of each of the specimens. Then, the average value of the thus obtained peeling strengths of the ten specimens was obtained as the T-type peeling strength.

(12) Flexibility of Nonwoven Fabric [Compression Resistance (cN)]:

Specifically, five specimens each having a length of 10 cm and a width of 5 cm were prepared. Each of the specimens was rolled into a cylindrical article so as for the length direction of the specimen to be the circumferential direction. The circumferential ends of each of the specimens were bonded to each other to prepare a sample for the compression resistance measurement. By using a constant elongation tensile tester (Tensilon UTM-4-1-100, manufactured by Orientec Co., Ltd.), each of the measurement specimens was compressed in the axial direction thereof at a compression speed of 5 cm/min, and the average value of the thus obtained maximum loads of the specimens was defined as the compression resistance (cN). The compression resistance is interpreted that the smaller the value thereof is, the better the flexibility is.

(13) Biodegradability:

A nonwoven fabric was embedded for 3 months in mature compost maintained at 58° C., and thereafter, the nonwoven fabric was taken out. Accordingly, the following two cases were evaluated as satisfactory in biodegradability and were marked with G (good): the case where when taken out, the nonwoven fabric did not maintain the shape thereof, and the case where when taken out, the nonwoven fabric had a tensile strength decreased to 50% or less of the initial strength value as measured before embedding although the nonwoven fabric maintained the shape thereof. On the contrary, the case where when taken out, the nonwoven fabric maintained the shape thereof and had a tensile strength of 50% or more of the initial tensile strength as measured before embedding was evaluated as poor in biodegradability and was marked with P (poor).

### Example 1

A polylactic acid polymer (brand name: U'zS-17, manufactured by Toyota Motor Corporation; hereinafter, abbreviated as “P1”) having a melting point of 176° C., a MFR1 value of 22 g/10 min and a MFR2 value of 45 g/10 min was prepared as a core component.

An aliphatic polyester polymer (brand name: GSPla, FZ71PD, manufactured by Mitsubishi Chemical Corporation; hereinafter abbreviated as “P2”) having a melting point of 114° C., a MFR3 value of 22 g/10 min and a MFR4 value of 25 g/10 min, and including 1,4-butanediol and succinic acid as the constituent components was prepared. The crystallization rate index tmax1 of the aliphatic polyester polymer was 7.4 minutes.

A master batch in which P1 was used as a base and 20% by mass of talc (TA) as a crystal nucleating agent was contained as kneaded with P1 was prepared.

The individual ingredients were separately weighed out in such a way that the composite ratio between P1 and P2 was P1:P2=1:1 by mass ratio, the content of talc in the molten polymer of P1 was 0.5% by mass, and additionally the content of N,N′-ethylenebis(stearamide) acid amide as an amide wax in the molten polymer of P2 was 0.5% by mass. Thereafter, P1 and P2 were respectively melted at 200° C. with separate melt extruders. Thus, melt-spinning was performed by using a spinneret capable of forming a sheath-core type filaments cross section in such a way that P1 formed the core portion and the P2 formed the sheath portion, at a mass out flow rate each orifice of 0.70 g/min.

The spin-twisted filaments were cooled with a heretofore known cooling device, thereafter successively drawn for thinning at a drawing speed of 1900 m/min with an air sucker disposed under the spinneret, subjected to spreading-open with a heretofore known fiber opening device and captured and deposited as web on the moving screen conveyer. At the time of spreading-open, most of the constituent filaments were separated, neither stuck filaments nor bundled filaments were found, and thus the spreading-open property was satisfactory. The fineness of the deposited composite filament was found to be 3.6 dtex.

Next, the web was made to pass for heat treatment through a embossing device composed of an embossing roller and a metal roller having a flat surface, and thus a nonwoven fabric having a weight of 20 g/m² was obtained. The embossing conditions were such that the surface temperature of each of both rollers was set at 100° C., the embossing roller had a sculptural pattern composed of circles each having an area of 0.6 mm², the pressure bonding point density was 20 points/cm², and the proportion of the pressure bonding area was 15%.

The performances of the obtained nonwoven fabric are shown in Table 1.

The amide waxes listed in Table 1 are specifically as follows:

Amide wax 1: N,N′-ethylenebis(stearamide)

Amide wax 2: N,N′-ethylenebis-12-hydroxy(stearamide)

Amide wax 3: N,N′-ethane-1,2-diylbishexadecan-1-amide

### Example 2

A polylactic acid polymer (brand name: 6201D, manufactured by NatureWorks LLC; hereinafter, abbreviated as “P3”) having a melting point of 168° C., a MFR1 value of 20 g/10 min and a MFR2 value of 40 g/10 min was prepared as a core component. In the melt-spinning, the melting temperature in the melt extruder was set at 220° C. and the drawing speed was set at 2250 m/min, and thus a composite filament having the fineness of 3.1 dtex was obtained. As an embossing condition, the surface temperature of each of both rollers was set at 90° C. Otherwise in the same manner as in Example 1, a nonwoven fabric was obtained.

The performances of the obtained nonwoven fabric are shown in Table 1.

### Example 3

The amount of the amide wax contained in P3 was set at 0.3% by mass. Otherwise in the same manner as in Example 2, a nonwoven fabric was obtained.

The performances of the obtained nonwoven fabric are shown in Table 1.

### Example 4

As compared to Example 1, the amide wax contained in P2 was altered to N,N′-ethylenebis-12-hydroxystearamide. Otherwise in the same manner as in Example 1, a nonwoven fabric was obtained.

The performances of the obtained nonwoven fabric are shown in Table 1.

### Example 5

P3 was prepared as a core component. Additionally, as compared to Example 2, the single hole discharge rate was set at 1.6 g/min, the drawing speed was set at 2000 m/min and the fineness was set at 7.4 dtex. Otherwise in the same manner as in Example 2, a nonwoven fabric was obtained.

The performances of the obtained nonwoven fabric are shown in Table 1.

### Example 6

As compared to Example 2, the composite ratio between the core portion and the sheath portion was set to satisfy a relation that core portion/sheath portion=2/1 by mass ratio, the drawing speed was set at 2000 m/min and the weight of the nonwoven fabric was set at 20 g/m². Otherwise in the same manner as in Example 2, a nonwoven fabric made of a composite filament having a fineness of 3.5 dtex was obtained.

The performances of the obtained nonwoven fabric are shown in Table 2.

### Example 7

As compared to Example 2, the composite ratio between the core portion and the sheath portion was set to satisfy a relation that core portion/sheath portion=1/2 by mass ratio, the drawing speed was set at 2000 m/min and the weight of the nonwoven fabric was set at 20 g/m². Otherwise in the same manner as in Example 2, a nonwoven fabric made of a composite filament having the fineness of 3.5 dtex was obtained.

The performances of the obtained nonwoven fabric are shown in Table 2.

### Example 8

As compared to Example 2, the amide wax was altered to N,N′-ethane-1.2-diylbishexadecan-1-amide. Otherwise in the same manner as in Example 2, a nonwoven fabric was obtained.

The performances of the obtained nonwoven fabric are shown in Table 2.

Each of the nonwoven fabrics of Examples 1 to 8 included a polylactic acid polymer and an aliphatic polyester polymer, the aliphatic polyester polymer included as the constituent components thereof 1,4-butanediol and succinic acid, and the melting point of the aliphatic polyester polymer was lower, by 50° C. or more, than the melting point of the polylactic acid polymer. Therefore, each of the nonwoven fabrics of Examples 1 to 8 was excellent in the stability at the heat processing and in the heat sealing property. The aliphatic polyester polymer included the amide wax in a content of 0.1 to 1.0% by mass, and consequently the friction between the filaments at the spreading-open was able to be diminished. Thus, webs satisfactory in spreading-open property were able to be produced, and hence nonwoven fabrics satisfactory in flexibility were able to be obtained.

### Comparative Example 1

P1 was used as the core component and P2 was used as the sheath component, and no additive was added to the sheath component.

Otherwise, in the same manner as in Example 1, an attempt was made to obtain a nonwoven fabric.

However, the obtained filaments were stuck, and consequently no nonwoven fabric satisfactory in spreading-open property was able to be obtained.

The results obtained for Comparative Example 1 are shown in Table 2.

### Comparative Example 2

P1 was prepared as the core component.

Prepared was an aliphatic polyester polymer (brand name: GSPla, AZ71TN, manufactured by Mitsubishi Chemical Corporation; hereinafter abbreviated as “P5”) having a melting point of 110° C., a MFR3 value of 26 g/10 min and a MFR4 value of 52 g/10 min, and including as the constituent components thereof an aliphatic diol and an aliphatic dicarboxylic acid and being copolymerized with lactic acid. The crystallization rate index tmax1 of this aliphatic polyester polymer was unable to be detected. In other words, this aliphatic polyester polymer was allowed to stand under the measurement conditions for 60 minutes, but no crystallization peak was detected.

A master batch in which P1 was used as a base and 20% by mass of talc (TA) as a crystal nucleating agent was contained as kneaded with P1 was prepared.

The individual ingredients were separately weighed out in such a way that the composite ratio between P1 and P5 was P1:P5=1:1 by mass ratio, the content of talc in the molten polymer of P1 was 0.5% by mass, and additionally the content of N,N′-ethylenebis(stearaamide) as an amide wax in the molten polymer of P5 was 0.5% by mass. Thereafter, P1 and P5 were respectively melted at 200° C. with separate melt extruders. Thus, melt-spinning was performed by using a spinneret capable of forming a sheath-core type filament cross section in such a way that P1 formed the core portion and the P5 formed the sheath portion, at a single hole discharge rate of 0.70 g/min.

However, the obtained filaments were stuck, and consequently no nonwoven fabric satisfactory in spreading-open property was able to be obtained.

The results obtained for Comparative Example 2 are shown in Table 2.

TABLE 1

| | | | | Ex. 1 | Ex. 2 | Ex. 3 | Ex. 4 | Ex. 5 |
|---|---|---|---|---|---|---|---|---|
| Core component | Brand name | | — | U'zS-17 | 6201D | 6201D | U'zS-17 | 6201D |
| | Melting point | | ° C. | 176 | 168 | 168 | 176 | 168 |
| | MFR 1 (210° C.) | | g/10 min | 22 | 20 | 20 | 20 | 20 |
| | MFR 2 (230° C.) | | g/10 min | 45 | 40 | 40 | 40 | 40 |
| | Additive | | — | TA | TA | TA | TA | TA |
| | Crystallization rate index | | min | 5.5 | 7.4 | 7.4 | 5.5 | 7.4 |
| | (tmax3) | | | | | | | |
| Sheath | Brand name | | — | FZ71PD | FZ71PD | FZ71PD | FZ71PD | FZ71PD |
| component | Melting point | | ° C. | 114 | 114 | 114 | 114 | 114 |
| | MFR 3 (210° C.) | | g/10 min | 22 | 22 | 22 | 22 | 22 |
| | MFR 4 (230° C.) | | g/10 min | 25 | 25 | 25 | 25 | 25 |
| | MFR ratio (MFR 3/MFR 1) | | — | 1.0 | 1.1 | 1.1 | 1.1 | 1.1 |
| | MFR ratio (MFR 4/MFR 2) | | — | 0.6 | 0.6 | 0.6 | 0.6 | 0.6 |
| | Organic additive | Type | — | Amide wax | Amide wax | Amide wax | Amide wax | Amide wax |
| | | | | 1 | 1 | 1 | 2 | 1 |
| | | Addition | % by mass | 0.5 | 0.5 | 0.3 | 0.5 | 0.5 |
| | | amount | | | | | | |
| | Crystallization rate index | | min | 7.4 | 7.4 | 7.4 | 7.4 | 7.4 |
| | (tmax1) | | | | | | | |
| | Crystallization rate index | | min | 1.1 | 1.1 | 1.5 | 2.0 | 1.1 |
| | (tmax2) | | | | | | | |
| Physical | Filament cross section | | — | Sheath- | Sheath- | Sheath- | Sheath- | Sheath- |
| properties of | | | | core | core | core | core | core |
| composite | Composite ratio (core/sheath) | | Mass | 1/1 | 1/1 | 1/1 | 1/1 | 1/1 |
| filament | | | ratio | | | | | |
| | Fineness | | dtex | 3.6 | 3.1 | 3.1 | 3.5 | 7.4 |
| Production | Melt extrusion temperature | | ° C. | 200 | 220 | 220 | 200 | 220 |
| conditions | Drawing speed | | m/min | 1900 | 2250 | 2250 | 2000 | 2000 |
| | Spreading-open property | | — | E | E | E | G | E |
| | Thermocompression | Means | — | Embossing | Embossing | Embossing | Embossing | Embossing |
| | bonding | Temperature | ° C. | 100 | 90 | 90 | 90 | 90 |
| Physical | Weight | | g/m² | 20 | 20 | 30 | 20 | 20 |
| properties of | Tensile strength | MD | N/5 cm | 44 | 58 | 93 | 60 | 43 |
| nonwoven | | CD | N/5 cm | 14 | 21 | 32 | 25 | 18 |
| fabric | Elongation | MD | % | 30 | 25 | 28 | 28 | 20 |
| | | CD | % | 41 | 28 | 28 | 32 | 21 |
| | Crystallization | Tc1 | ° C. | 115 | 108 | 108 | 115 | 108 |
| | temperature on | Tc2 | ° C. | 86 | 82 | 82 | 86 | 82 |
| | cooling | | | | | | | |
| | Heat of | Hexo2 | J/g | 34 | 32 | 32 | 34 | 30 |
| | crystallization | | | | | | | |
| | Thermal shrinkage | MD | % | 1.1 | 2.0 | 2.0 | 1.0 | 2.5 |
| | rate | MD | % | −1.6 | −1.0 | −1.0 | −1.5 | −0.5 |

| | | | | | | | |
|---|---|---|---|---|---|---|---|
| Heat-sealing | Heat-sealing temperature | ° C. | 130 | 130 | 130 | 130 | 130 |
| processability | Heat-sealing property | — | G | G | G | G | G |
| | T-type peeling strength | N/3 cm | 15 | 20 | 35 | 20 | 25 |

| | | | | | | |
|---|---|---|---|---|---|---|
| Flexibility | cN | 2 | 8 | 26 | 15 | 30 |
| Biodegradability | — | G | G | G | G | G |

TABLE 2

| | | | | Ex. 6 | Ex. 7 | Ex. 8 | Com. Ex. 1 | Com. Ex. 2 |
|---|---|---|---|---|---|---|---|---|
| Core component | Brand name | | — | 6201D | 6201D | 6201D | U'zS-17 | U'zS-17 |
| | Melting point | | ° C. | 168 | 168 | 168 | 176 | 176 |
| | MFR 1 (210° C.) | | g/10 min | 20 | 20 | 20 | 22 | 22 |
| | MFR 2 (230° C.) | | g/10 min | 40 | 40 | 40 | 45 | 45 |
| | Additive | | — | TA | TA | TA | TA | TA |
| | Crystallization rate index | | min | 7.4 | 7.4 | 7.4 | 5.5 | 5.5 |
| | (tmax3) | | | | | | | |
| Sheath | Brand name | | — | FZ71PD | FZ71PD | FZ71PD | FZ71PD | AZ71TN |
| component | Melting point | | ° C. | 114 | 114 | 114 | 114 | 110 |
| | MFR 3 (210° C.) | | g/10 min | 22 | 22 | 22 | 22 | 26 |
| | MFR 4 (230° C.) | | g/10 min | 25 | 25 | 25 | 25 | 52 |
| | MFR ratio (MFR 3/MFR 1) | | — | 1.1 | 1.1 | 1.1 | 1.0 | 1.2 |
| | MFR ratio (MFR 4/MFR 2) | | — | 0.6 | 0.6 | 0.6 | 0.6 | 1.2 |
| | Organic additive | Type | — | Amide wax | Amide wax | Amide wax | None | Amide wax |
| | | | | 1 | 1 | 3 | | 1 |
| | | Addition | % by mass | 0.5 | 0.5 | 0.5 | 0 | 0.5 |
| | | amount | | | | | | |
| | Crystallization rate index | | min | 7.4 | 7.4 | 7.4 | 7.4 | Not |
| | (tmax1) | | | | | | | detectable |
| | Crystallization rate index | | min | 1.1 | 1.1 | 1.2 | 2.5 | 10.0 |
| | (tmax2) | | | | | | | |
| Physical | Filament cross section | | — | Sheath- | Sheath- | Sheath- | Sheath- | Sheath- |
| properties of | | | | core | core | core | core | core |
| composite | Composite ratio (core/sheath) | | Mass | 2/1 | 1/2 | 1/1 | 1/1 | 1/1 |
| filament | | | ratio | | | | | |
| | Fineness | | dtex | 3.5 | 3.5 | 3.1 | Not | Not |
| | | | | | | | measurable | measurable |
| Production | Melt extrusion temperature | | ° C. | 220 | 220 | 220 | 200 | 200 |
| conditions | Drawing speed | | m/min | 2000 | 2000 | 2000 | Not | Not |
| | | | | | | | measurable | measurable |
| | Spreading-open property | | — | G | E | G | P | P |
| | Thermocompression | Means | — | Embossing | Embossing | Embossing | — | — |
| | bonding | Temperature | ° C. | 90 | 90 | 90 | — | — |
| Physical | Weight | | g/m² | 20 | 20 | 20 | — | — |
| properties of | Tensile strength | MD | N/5 cm | 80 | 40 | 43 | — | — |
| nonwoven | | CD | N/5 cm | 30 | 14 | 12 | — | — |
| fabric | Elongation | MD | % | 30 | 22 | 26 | — | — |
| | | CD | % | 32 | 25 | 26 | — | — |
| | Crystallization | Tc1 | ° C. | 108 | 108 | 115 | — | — |
| | temperature on | Tc2 | ° C. | 82 | 82 | 82 | — | — |
| | cooling | | | | | | | |
| | Heat of | Hexo2 | J/g | 22 | 45 | 35 | — | — |
| | crystallization | | | | | | | |
| | Thermal shrinkage | MD | % | 1.5 | 1.0 | 2.0 | — | — |
| | rate | CD | % | −1.0 | −1.0 | −1.0 | — | — |

| | | | | | | | |
|---|---|---|---|---|---|---|---|
| Heat-sealing | Heat-sealing temperature | ° C. | 130 | 130 | 130 | — | — |
| processability | Heat-sealing property | — | G | G | G | — | — |
| | T-type peeling strength | N/3 cm | 15 | 30 | 25 | — | — |

| | | | | | | |
|---|---|---|---|---|---|---|
| Flexibility | cN | 12 | 6 | 15 | — | — |
| Biodegradability | — | G | G | G | — | — |

What is claimed is:

1. A nonwoven fabric which is formed of composite filaments by a spunbond method, wherein:
the composite filament comprises a polylactic acid polymer having a melting point of not lower than 160° C. and an aliphatic polyester polymer having a melting point lower, by not less than 50° C., than the melting point of the polylactic acid polymer;
the aliphatic polyester polymer forms at least a portion of a filament surface; and
the aliphatic polyester polymer comprises as constituent components thereof 1,4-butanediol and succinic acid, and at the same time, comprises 0.1 to 1% by mass of an amide wax.

2. The nonwoven fabric according to claim 1, wherein the fabric is formed of composite filaments which are sheath-core type filaments in which the polylactic acid polymer forms a core portion thereof and the aliphatic polyester polymer forms a sheath portion thereof, and a composite ratio between the core portion and the sheath portion satisfies a relation that core portion/sheath portion=3/1 to 1/3 by mass ratio.

3. The nonwoven fabric according to claim 1, wherein:
when differential thermal analysis is performed at a temperature decrease rate of 10° C./min after melting has been performed at a temperature increase rate of 10° C./min, a crystallization temperature Tc1 on cooling due to the polylactic acid polymer and a crystallization temperature Tc2 on cooling due to the aliphatic polyester polymer are present;
Tc2 is not lower than 80° C. and not higher than 90° C.; and
a heat of crystallization Hexo2 of the aliphatic polyester polymer is not less than 30 J/g.

4. A production method of a nonwoven fabric comprising the steps of:
preparing a polylactic acid polymer having a melting point of not lower than 160° C. and an aliphatic polyester polymer which comprises, as constituent components thereof, 1,4-butanediol and succinic acid and has a melting point lower, by not less than 50° C., than the melting point of the polylactic acid polymer;
mixing an amide wax so as to have a content of 0.1 to 1% by mass in the aliphatic polyester polymer;
melting separately the polylactic acid polymer and the aliphatic polyester polymer at a temperature of (Tm+75)° C. to (Tm+120)° C. wherein the Tm is the melting point of the aliphatic polyester polymer;
performing spinning by using a composite spinneret which allows the aliphatic polyester polymer to form at least a portion of a filament surface in a filament cross section;
cooling, drawing and subsequently spreading-open filaments that have been spin-twisted from the spinneret; and
forming a nonwoven web by depositing thus obtained filaments.

5. The production method of a nonwoven fabric according to claim 4, wherein used as the aliphatic polyester polymer is a polymer which has a crystallization rate index of 3 to 10 minutes as determined by a differential thermal analysis of an isothermal crystallization performed under the conditions that the polymer is heated to 200° C. at a temperature increase rate of 500° C./min, the polymer is maintained at 200° C. for 5 minutes, thereafter the polymer is cooled to 90° C. at a temperature decrease rate of 500° C./min and the polymer is maintained at 90° C. for crystallization, and has a melt viscosity gradient of not more than 20 g/10 min obtained as a difference between a melt flow rate at 230° C. with a load of 20.2 N (2160 gf) and a melt flow rate at 210° C. with a load of 20.2 N (2160 gf), both of the melt flow rates being measured according to a method described in ASTM-D-1238(E).

6. The production method of a nonwoven fabric according to claim 4, wherein used as the polylactic acid polymer and the aliphatic polyester polymer are these two polymers for which a melt flow rate ratio measured at 210° C. with a load of 20.2 N (2160 gf) according to the method described in ASTM-D-1238(E) satisfies a relation that the melt flow rate of the aliphatic polyester polymer/the melt flow rate of the polylactic acid polymer=0.3 to 1.5, and a melt flow rate ratio measured at 230° C. with a load of 20.2 N (2160 gf) according to the method described in ASTM-D-1238(E) satisfies a relation that the melt flow rate of the aliphatic polyester polymer/the melt flow rate of the polylactic acid polymer=not more than 0.7.

7. A biodegradable bag-shaped article which is formed of the nonwoven fabric according to claim 1, and is allowed to take a bag-shaped structure by being provided with a heat-sealing portion in which constituent filaments are bonded to each other due to melting or softening of the aliphatic polyester polymer.

8. A biodegradable sanitary article which is formed of the nonwoven fabric according to claim 1.
